(19) United States
(12) Patent Application Publication
(10) Pub. No.: US 2013/0004746 A1
(43) Pub. Date: Jan. 3, 2013

(54) Phthalocyanines and Their use in Ink Jet Printing

(76) Inventor: Prakash Patel, Blackley (GB)

(21) Appl. No.: 13/583,679

(22) PCT Filed: Mar. 8, 2011
(86) PCT No.: PCT/GB2011/050447

§ 371 Date: Sep. 10, 2012

(30) Foreign Application Priority Data
Mar. 17, 2010 (GB) 1004416.2

(51) Int. Cl. C09D 11/02; B32B 3/10; B41J 2/175; C09B 47/04

(52) U.S. Cl. 428/195.1; 540/142; 540/140; 106/31.49; 347/100; 347/86

(57) ABSTRACT

A process for preparing phthalocyanine or metallo-phthalocyanine dyes and salts thereof. Also novel compounds, inks, printing processes, printed materials and ink-jet cartridges.

This invention relates to dyes, compositions and inks, to printed substrates, to printing processes and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzle used in the printer. Storage stability is also important to avoid particle formation that could block the printer nozzles especially since consumers can keep an ink-jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

The dyes, which are primarily designed for ink-jet printing may also in some cases be suitable for use in the formation of color filters.

The present invention provides a process for preparing phthalocyanine dyes and salts thereof or metallo-phthalocyanine dyes and salts thereof which comprises the stages of:
(a) cyclising a compound of Formula (1) with a compound of Formula (2)

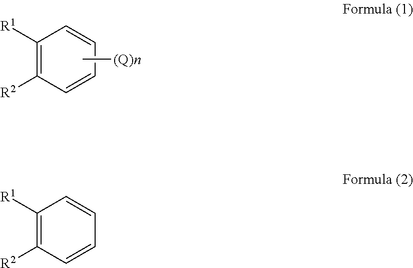

wherein:
R¹ and R² are cyano, carboxy, carboxamide or together form a group of formula

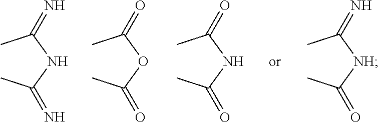

Q is NO₂, F or Cl; and
n is 1 to 4;
   wherein the cyclisation process is carried out in the presence of a suitable nitrogen source (if required) and a metal salt (if required);
(b) chlorosulfonating the mixture of phthalocyanines or metallo-phthalocyanines formed in stage (a);
(c) reacting the mixture of phthalocyanines or metallo-phthalocyanines carrying sulfonyl chloride groups, formed in stage (b), with ammonia and one or more amines.

Preferably the phthalocyanine or metallo-phthalocyanine dyes are metallo-phthalocyanine dyes and more preferably copper or nickel phthalocyanine dyes and particularly copper phthalocyanine dyes and salts thereof.

Preferably R¹ and R² are cyano or carboxy, especially cyano. More preferably R¹ and R² are the same.

Preferably Q is Cl.

It is preferred that n is 2 to 4, more preferably n is 4.

In stage (a) of the process of the present invention, depending on the reactants and reaction conditions, it may be advantageous to incorporate a base in the cyclisation reaction. Any suitable base may be used. Preferably the base is 1,8-diazabicyclo[5.4.0]undec-7-ene (DBU).

When the product of the process is a metallo-phthalocyanine then a metal salt is required. Any suitable salt may be used. For example, CuCl₂ when the product of the reaction is copper phthalocyanine.

When R¹ and R² do not contain nitrogen then a source of nitrogen is required if the phthalocyanine ring is to be formed. Suitable sources of nitrogen include ammonia and urea.

Stage (a) of the process of the present invention is preferably carried out in any compatible solvent. Preferred solvents include ethylene glycol and diethylene glycol.

The preferred molar ratio of the compounds of Formula (1) to compounds of Formula (2) is in the range of from 10/1 to 1/10. More preferably the ratio of the compounds of Formula (1) to compounds of Formula (2) is in the range of from 3/1 to 1/3.

The cyclisation reaction of stage (a) is preferably performed at a temperature in the range of from 80 to 180° C., more preferably in the range of from 100 to 150° C. and especially in the range of from 110 to 130° C.

Preferably the cyclisation is performed in the range of from 1 to 12 hours, more preferably in the range of from 2 to 8 hours and especially in the range of from 3 to 6 hours

The length of time for which the cyclisation is performed depends on the temperature used. For example higher temperatures require less time and lower temperatures require more time. In a preferred embodiment cyclisation is performed at a temperature in the range of from 110 to 130° C. for a time in the range of from 3 to 6 hours.

Compounds of Formula (1) and (2) may be prepared by methods well known in the art. They are also commonly commercially available.

The chlorosulfonating agent used in stage (b) may be any suitable chlorosulfonating agent such as, for example, chlorosulfonic acid. An active halide compound may preferably be added to the chlorosulfonic acid, for example phosphorous pentachloride, phosphorous oxychloride or phosphorous trichloride. Preferably the chlorosulfonating agent comprises a mixture of chlorosulfonic acid and phosphorous oxychloride. Preferably the ratio of chlorosulfonic acid to phosphorous oxychloride is in the range of 25 molar equivalents to 0.5 molar equivalents and more preferably 12.5 molar equivalents to 1.0 molar equivalent.

The preferred molar ratio of the chlorosulfonating agent to the mixture of phthalocyanine or metallo-phthalocyanine dyes obviously depends on the nature of the reactants. However one preferred ratio of chlorosulfonating agent to copper phthalocyanine dyes is in the range of from 100 molar equivalents to 1.0 molar equivalent and more preferably is in the range of from 50 molar equivalents to 1.0 molar equivalent.

Preferably chlorosulfonation is performed at a temperature in the range of from 90 to 180° C., more preferably in the range of from 120 to 150° C., especially in the range of from 130 to 148° C. and more especially in the range of from 135 to 145° C.

Preferably chlorosulfonation is performed for in the range of from 0.5 to 16 hours, more preferably in the range of from 1 to 8 hours and especially in the range of from 1.5 to 5.0 hours.

The length of time for which the chlorosulfonation is performed depends on the temperature used. For example higher temperatures require less time and lower temperatures require more time. In a preferred embodiment chlorosulfonation is performed at a temperature of 135 to 145° C. for a time in the range of from 1.5 to 8.0 hours and more preferably in the range of from 2 to 7 hours.

Condensation of the product of stage (b) with ammonia and one or more amines in stage (c) is preferably performed at a temperature in the range of from 10 to 80° C., and more preferably at a temperature in the range of from 20 to 60° C. for a time in the range of from 1 to 14 hours and more preferably in the range of from 2 to 6 hours. The reactions with ammonia and the amine(s) can be carried out sequentially though preferably in stage (c) the mixture of phthalocyanine or metallo-phthalocyanines carrying sulfonyl chloride groups is reacted with ammonia and the amine(s) at the same time.

Any suitable source of ammonia may be used such as, for example, concentrated ammonia solution or ammonium chloride.

If an amine is reacted with the mixture of phthalocyanine or metallo-phthalocyanines carrying sulfonyl chloride groups in stage (c) then it may be any amine able to react with a sulfonyl chloride to yield a sulfonamide.

Preferably the amine(s) reacted in stage (c) is/are of Formula (3)

NHR³R⁴ Formula (3)

wherein:
R³ is selected from the group consisting of H, optionally substituted alkyl (optionally interrupted by one or more hetero atoms); optionally substituted aryl; and optionally substituted heterocyclylene (including optionally substituted heteroaryl); and
R⁴ is selected from the group consisting of optionally substituted alkyl (optionally interrupted by one or more hetero atoms); optionally substituted aryl; and optionally substituted heterocyclylene (including optionally substituted heteroaryl).

Preferably R³ is selected from the group consisting of H and optionally substituted C₁₋₈alkyl, especially C₁₋₈alkyl carrying one or more water solubilising groups selected from the group consisting of —OH, —SO₃H, —CO₂H and —PO₃H₂. It is especially preferred that R³ is H or optionally substituted C₁₋₄alkyl, more especially that R³ is H or unsubstituted C₁₋₄alkyl, particularly methyl and particularly that R³ is H.

Preferably R⁴ is optionally substituted C₁₋₈alkyl (optionally interrupted by one or more hetero atoms).

Preferably the amine of Formula (3) carries either directly or on a substituent a water solubilising substituent selected from the group consisting of —SO₃H, —CO₂H and —PO₃H₂.

Preferred amine(s) of Formula (3) is/are of Formula (4):

NHR⁵-L-NR⁶R⁷ Formula (4)

wherein:
L is a divalent linking group;
R⁵ is H or optionally substituted alkyl;
R⁶ is H, optionally substituted alkyl (optionally interrupted by one or more hetero atoms), optionally substituted aryl or optionally substituted heterocyclyl; and
R⁷ is optionally substituted alkyl (optionally interrupted by one or more hetero atoms), optionally substituted aryl or optionally substituted heterocyclyl.

Preferably L, the divalent linking group, is selected from the group consisting of: optionally substituted alkylene (optionally interrupted by one or more hetero atoms); optionally substituted arylene; and optionally substituted heterocyclylene (including optionally substituted heteroarylene).

More preferably L is optionally substituted alkylene, especially optionally substituted C₁₋₄alkylene, more especially unsubstituted C₁₋₄alkylene and particularly —CH₂CH₂—.

Preferably R⁵ is H or optionally substituted C₁₋₄alkyl, more preferably H, methyl or ethyl, especially H or methyl and more especially H.

Preferably R⁶ and R⁷ are independently H, optionally substituted C₁₋₄alkyl or optionally substituted heterocyclyl.

Preferably R⁶ is H or optionally substituted C₁₋₄alkyl, more preferably H, methyl or ethyl, especially H or methyl and more especially H.

Preferably R⁷ is an optionally substituted triazinyl group (where preferably the triazinyl group or substituent thereon carries at least one water solubilising substituent selected from the group consisting of —SO₃H, —CO₂H and —PO₃H₂).

More preferably R⁷ is a group of Formula (5)

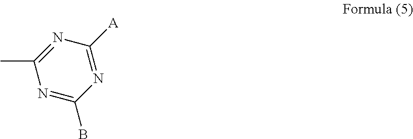

wherein:
A is selected from the group consisting of —OR⁸, —SR⁸, —NR⁸R⁹;
B is selected from the group consisting of —OR¹⁰, —SR¹⁰, —NR¹⁰R¹¹;
R⁸, R⁹, R¹⁰ and R¹¹ are independently H, optionally substituted alkyl, optionally substituted aryl or optionally substituted heterocyclyl provided that at least one of the groups represented by R⁸, R⁹, R¹⁰ and R¹¹ carries at least one substituent selected from the group consisting of —SO₃H, —CO₂H and —PO₃H₂.

Preferred groups represented by A and B may be independently selected from the group consisting of —OH, —NHCH₃, —N(CH₃)₂, —NHC₂H₄SO₃H₂, —N(CH₃)C₂H₄SO₃H₂, —NC₃H₆SO₃H, —NHdisulfophenyl, —NHsulfophenyl, —NHcarboxyphenyl or —NHdicarboxyphenyl, —NHsulfonaphthyl, —NHdisulfonaphthyl, —NHtrisulfonaphthyl, —NHcarboxyonaphthyl, NHdicarboxyonaphthyl, NHtricarboxyonaphthyl-NHsulfoheterocyclyl, —NHdisulfoheterocyclyl or —NHtrisulfoheterocyclyl.

It is especially preferred that R⁷ is a group of Formula (6)

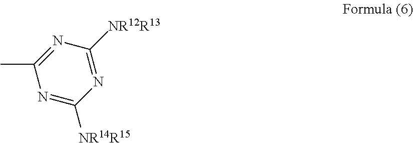

wherein:
R¹² is H or optionally substituted C₁₋₄alkyl;
R¹³ is H or optionally substituted C₁₋₄alkyl;
R¹⁴ is H or optionally substituted C₁₋₄alkyl;
R¹⁵ is optionally substituted alkyl, optionally substituted aryl or optionally substituted heterocyclyl carrying at least one substituent selected from the group consisting of —SO₃H, —CO₂H and —PO₃H₂.

Preferably R¹² is H or unsubstituted C₁₋₄alkyl, more preferably R¹² is H or methyl, especially H.

Preferably R¹³ is H or unsubstituted C₁₋₄alkyl, more preferably R¹³ is H or methyl, especially H.

Preferably R¹⁴ is H or unsubstituted C₁₋₄alkyl, more preferably R¹⁴ is H or methyl, especially H.

In a preferred embodiment R¹², R¹³ and R¹⁴ are all independently either H or methyl, more preferably R¹², R¹³ and R¹⁴ are all H.

Preferably R¹⁵ is optionally substituted aryl carrying at least one substituent selected from the group consisting of —SO₃H, —CO₂H and —PO₃H₂. More preferably R¹⁵ is an aryl group (particularly a phenyl group) carrying 1 to 3, especially 2, —SO₃H or —CO₂H groups.

Preferred optional substituents which may be present on any one of L, R³, R⁴, R⁵, R³, R⁷, R⁸, R⁹, R¹⁰, R¹¹, R¹², R¹³, R¹⁴ and R¹⁵ are independently selected from: optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), phosphato, nitro, cyano, halo, ureido, hydroxy, ester, —NR^{a}R^{b}, —COR^{a}, —CONR^{a}R^{b}, —NHCOR^{a}, carboxyester, sulfone, and —SO₂NR^{a}R^{b}, wherein R^{a} and R^{b} are each independently H, optionally substituted alkyl (especially C₁₋₄-alkyl), optionally substituted aryl or optionally substituted heteroaryl. If L, R³, R⁴, R⁵, R³, R⁷, R⁸, R⁹, R¹⁰, R¹¹, R¹², R¹³, R¹⁴ and R¹⁵ comprise a cyclic group then the cyclic group may also carry an optionally substituted alkyl (especially C₁₋₄-alkyl) substituent. Optional substituents for any of the substituents described for L, R³, R⁴, R⁵, R3, R⁷, R⁸, R⁹, R¹⁰, R¹¹, R¹², R¹³, R¹⁴ and R¹⁵ may be selected from the same list of substituents.

A skilled person will appreciate that the dye which is the product of these reactions will be a highly disperse mixture containing isomers which vary depending on the nature and relative positions of the component rings, and the nature and position of any substituents on these component rings.

A second aspect of the invention provides phthalocyanine dyes and salts thereof and/or metallo-phthalocyanine dyes and salts thereof obtainable by means of a process according to the first aspect of the invention.

Preferences are as described and preferred in the first aspect of the invention

Preferably the second aspect of the invention provides metallo-phthalocyanine dyes and salts thereof of Formula (7);

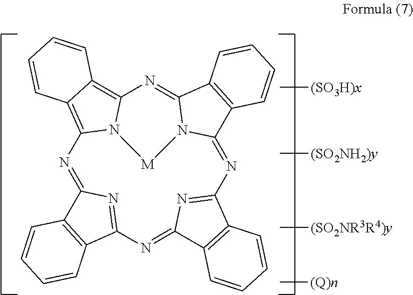

wherein
M is Ni or Cu;
R³ is selected from the group consisting of H, optionally substituted alkyl (optionally interrupted by one or more hetero atoms); optionally substituted aryl; and optionally substituted heterocyclylene (including optionally substituted heteroaryl);
R⁴ is selected from the group consisting of optionally substituted alkyl (optionally interrupted by one or more hetero atoms); optionally substituted aryl; and optionally substituted heterocyclylene (including optionally substituted heteroaryl);
Q is an electron withdrawing group;
N is 1 to 4;
x is greater than 0 and less than 4;
y is greater than 0 and less than 4;
z is greater than 0 and less than 4; and
y+z+w is greater than 0 and less than 4.

When these dyes are prepared as described in the first aspect of the invention they are a disperse mixture and so the values of x, y and z will be an average rather number than an integer.

Preferably x is in the range of 0.1 to 3, more preferably 0.1 to 1.

Preferably y is in the range of from 0.1 to 3, more preferably 0.5 to 2.

Preferably z is in the range of from 0.1 to 3, more preferably 0.5 to 2.

Preferably x+y+z is in the range of from 1 to 3.

Preferences for M, R³, R⁴, Q and n are as preferred above.

The dyes of the second aspect of the invention have attractive, strong shades and are valuable colorants for use in the preparation of cyan ink-jet printing inks. They benefit from a good balance of solubility, storage stability and fastness to water, ozone and light. In particular they display good bronzing characteristics and excellent wet fastness, light fastness and ozone fastness.

Acid or basic groups on all of the compounds disclosed in this invention, particularly acid groups, are preferably in the form of a salt. Thus, all Formulae shown herein include the compounds in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. The phthalocyanine or metallo-phthalocyanine dyes may be converted into a salt using known techniques.

Compounds disclosed in this specification may exist in tautomeric forms other than those shown. These tautomers are included within the scope of the present invention.

According to a third aspect of the present invention there is provided a composition comprising phthalocyanine dyes and salts thereof and/or metallo-phthalocyanine dyes and salts thereof, as described in the second aspect of the invention and a liquid medium.

Preferred compositions according to the third aspect of the invention comprise:
(a) from 0.01 to 30 parts of the dyes and salts thereof as described in the second aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethylene glycol monoallyl ether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethylene glycol, thiodiglycol, diethylene glycol and triethylene glycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Further colorants may be added to the ink to modify the shade and performance properties.

It is preferred that the composition according to the invention is ink suitable for use in an ink-jet printer. Ink suitable for use in an ink-jet printer is ink which is able to repeatedly fire through an ink-jet printing head without causing blockage of the fine nozzles therein. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20cP, more preferably less than 10cP, especially less than 5cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colorant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide (particularly chloride) ions.

If the composition according to the third aspect of the invention is to be used in forming film coatings, particularly in the manufacture a color filter, then it preferably further comprises a film-forming material.

Film forming inks may also comprise radical scavengers and/or UV absorbers to help improve light and heat fastness of the ink and resultant color filter.

A fourth aspect of the invention provides a process for forming an image on a substrate comprising applying a composition, preferably ink suitable for use in an ink-jet printer, according to the third aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred.

A fifth aspect of the present invention provides a material preferably paper, plastic, a textile, metal or glass, more preferably paper, an overhead projector slide or a textile material, especially paper more especially plain, coated or treated papers printed with phthalocyanine dyes and salts thereof and/or metallo-phthalocyanine dyes and salts thereof as described in the second aspect of the invention, a composition according to the third aspect of the invention or by means of a process according to the fourth aspect of the invention.

It is especially preferred that the printed material of the fifth aspect of the invention is a print on a photographic quality paper printed using a process according to the fourth aspect of the invention.

A final aspect of the present invention provides an ink-jet printer cartridge comprising a chamber and a composition, preferably ink suitable for use in an ink-jet printer, wherein the composition is in the chamber and the composition is as defined and preferred in the third aspect of the present invention.

The invention is further illustrated by the following Examples in which all parts and percentages are by weight unless otherwise stated.

### EXAMPLES

### Preparation of Intermediate A

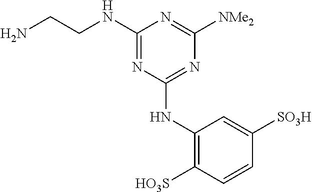 [SMILES: CN(C)c1nc(NCCN)nc(Nc2cc(S(=O)(=O)O)ccc2S(=O)(=O)O)n1]

Cyanuric chloride (9.23 g) was stirred in ice/water (2000 g) containing a few drops of calsolene oil at 0 to 5° C. A solution of 2,5-disulfoaniline (13.8 g) in water (50 ml) at pH 5 to 6 was then added drop-wise with stirring. The reaction mixture was stirred at 5° C. and pH 5 to 6 for 2 hours. The pH was then raised to 7 with 2M sodium hydroxide solution and the temperature to 20-25° C. and the reaction mixture was left for 1 hour. Dimethylamine (40%, 6.3 ml) was then added and the pH was adjusted to 8.5 to 9. The reaction mixture was stirred at room temperature and pH 8.5-9 for 2 hours, then at pH 8.5-9, 60° C. for 1 hour and for a further 1 hour at 80° C. before being allowed to cool overnight. The next day ethylenediamine (33 ml) was added to the mixture and the reaction was stirred at 80° C. for a further 2 hours. The volume of the reaction mixture was reduced to 200 ml using a rotary evaporator, NaCl (20 g) was added and the pH was lowered to 1 with concentrated HCl. The precipitate which formed was collected by filtration, washed with 20% NaCl and slurried in methanol (170 ml) and water (9 ml) at 60° C. for 1 hour. The solid was then collected by filtration, washed with methanol (25 ml) and dried to give the product (18.5 g).

### Preparation of Intermediate B

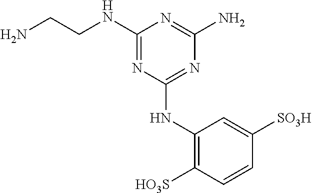 [SMILES: NCCNc1nc(N)nc(Nc2cc(S(=O)(=O)O)ccc2S(=O)(=O)O)n1]

Intermediate B was prepared as described for Intermediate A except that ammonia solution was used in place of dimethyamine solution.

### Preparation of Pigment A

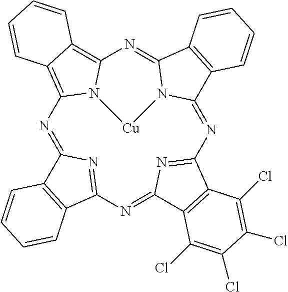

Phthalonitrile (19.2 g) and tetrachlorophthalonitrile (13.4 g) were added to diethylene glycol (110 g) and acetic acid (1.7 g). The reaction was heated to 140° C. for 1 hour, cooled to 120° C. and lithium acetate (3.8 g) was added followed by triethylorthoacetate (21 ml) and anhydrous copper (II) chloride (7.4 g). The reaction was stirred for 4 hours at 120° C., cooled to 80° C., and c HCl (20 ml) was added. The reaction was stirred for a further 1 hour and then isopropanol (300 ml) added. The solid which precipitated was filtered off and washed with hot water and isopropanol. The pigment was refluxed in isopropanol (500 ml) and water (100 ml), filtered while hot, washed with water and then acetone and dried to give the product (24 g).

Pigments B and C were prepared as Pigment A using the mole equivalent of pthalonitriles as shown in the table below.

| | Tetrachlorophthalonitrile | Phthalonitrile |
|---|---|---|
| Pigment | Mole equivalent used | Mole equivalent used |
| Pigment A | 1 | 3 |
| Pigment B | 0.5 | 3.5 |
| Pigment C | 2 | 2 |

### Example 1

Pigment A (14.28 g) was added to a stirred mixture of chlorosulphonic acid (120 g) and phosphorus oxychloride (12.4 g) over 10 minutes. The reaction was heated at 130° C. for 6 hours and cooled overnight to room temperature. The next day the mixture was drowned out into ice (600 g) and the precipitated solid filtered off and washed with saturated brine. Half this damp solid was then added to a solution of Intermediate A (4.61 g) in water (100 ml) at pH 8.5 and ammonium chloride (3.21 g) The reaction was then heated at 50-55° C. overnight whist maintaining the pH at 9.5 with 2M sodium hydroxide solution. pH then raised to 12 and reaction heated at 80° C. for 2 hours, cooled to 50° C. pH lowered to 8 with concentrated hydrochloric acid and sodium chloride added and precipitated dye filtered off. The dye was dissolved in water (400 ml), dialysed and dried (8.4 g).

### Examples 2 to 10

The dyes of Examples 2 to 6 were prepared as described in Example 1 except that the Pigment, intermediate and amine were varied as shown below

| | Pigment | | Ammonia |
|---|---|---|---|
| Example | (mol eq) | Amine (mol eq) | (mol eq) |
| 2 | Pigment A (1) | Intermediate A (1.5) | NH₄Cl (3) |
| 3 | Pigment B (1) | Intermediate A (1) | NH₄Cl (6) |
| 4 | Pigment B (1) | Intermediate A (1.5) | NH₄Cl (3) |
| 5 | Pigment C (1) | Intermediate A (1) | NH₄Cl (6) |
| 6 | Pigment C (1) | Intermediate A (1.5) | NH₄Cl (3) |
| 7 | Pigment A (1) | Intermediate B (1) | NH₄Cl (6) |
| 8 | Pigment A (1) | Intermediate B (1.5) | NH₄Cl (3) |
| 9 | Pigment A (1) | Ethanolamine (1) | NH₃* (1) |
| 10 | Pigment A (1) | Ethanolamine (1) | NH₃* (2) |

*added from a concentrated ammonia solution.

### Example 11

Pigment A (5 g) was added to stirred chlorosulfonic acid (16 g) and phosphorus oxychloride (1.7 g) over 10 minutes. The reaction was heated at 130° C. for 6 hours and cooled overnight to room temperature. The next day the mixture was drowned out into ice and precipitated solid was filtered off and washed with saturated brine. This solid was then added to conc ammonia solution (10 ml) and water (100 ml) and the reaction was then heated at 55° C. overnight whist maintaining the pH at 10.5 with conc ammonia solution. The reaction was then heated at 80° C. for 2 hours, cooled to 50° C. and the pH lowered to 8 with concentrated hydrochloric acid. Sodium chloride was added and the dye which precipitated dye was filtered off. The dye was dissolved in water (400 ml), at pH 9, dialysed and dried (4 g).

### Comparative Examples

The following dyes were used for comparative purposes.

Projet® Cyan 1 (Comparative Dye 1),

Projet Cyan 485 (Comparative Dye 2)

These are two commercial cyan dyes widely used in ink-jet printing; and

### Comparative Dye 3

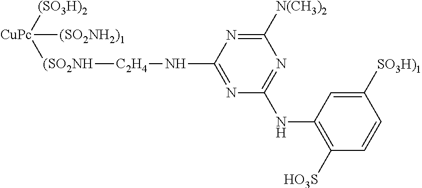

Comparative Dye 3 was prepared by the chlorosulfonation of commercially available copper phthalocyanine pigment followed by reaction with ammonium chloride and intermediate A (as described above in Example 1).

### Example 12

### Preparation of Ink

Ink was prepared by dissolving 3.5 g of the dyes prepared in Example 1 and Example 10 and the three Comparative Example Dyes in 96.5 g of a liquid medium comprising:

Diethylene glycol 7%

Ethylene glycol 7%

2-Pyrollidone 7%

Surfynol 465 1%

Tris buffer 0.2%

Water 77.8% (all % by weight)

and adjusting the pH of the ink to 8-8.5 using sodium hydroxide.

Surfynol® 465 is a surfactant from Air Products.

### Example 13

### Ink-Jet Printing

Inks prepared as described above were filtered through a 0.45 micron nylon filter and then incorporated into empty print cartridges using a syringe.

These inks were then ink-jet printed on to HP Advanced Photo Paper at 50% depth:

The prints were tested for ozone fastness by exposure to 1 ppm ozone at 40° C., 50% relative humidity for 24 hours in a Hampden 903 Ozone cabinet. Fastness of the printed ink to ozone was judged by the difference in the optical density before and after exposure to ozone.

Light-fastness of the printed image was assessed by fading the printed image in an Atlas® Ci5000 Weatherometer for 100 hours and then measuring the change in the optical density.

Optical density measurements were performed using a Gretag® spectrolino spectrophotometer set to the following parameters:

Measuring Geometry: 0°/45°

Spectral Range: 380-730 nm

Spectral Interval: 10 nm

Illuminant: D65

Observer: 2° (CIE 1931)

Density: Ansi A

External Filler: None

Light and Ozone fastness were assessed by the percentage change in the optical density of the print, where a lower figure indicates higher fastness, and the degree of fade. The degree of fade is expressed as ΔE where a lower figure indicates higher light fastness. ΔE is defined as the overall change in the CIE color co-ordinates L, a, b of the print and is expressed by the equation ΔE=(ΔL²+Δa²+Δb²)^{0.5}.

### Results

The results are shown in the following tables:

Ozone Fastness

| Dye | ΔE | ROD |
|---|---|---|
| Example 1 | 7 | 16 |
| Example 10 | 5 | 9 |
| Comparative Dye 1 | 33 | 54 |
| Comparative Dye 2 | 34 | 59 |
| Comparative Dye 3 | 16 | 37 |

Light Fastness

| Dye | ΔE | ROD |
|---|---|---|
| Example 1 | 4 | 13 |
| Example 10 | 5 | −10 |
| Comparative Dye 1 | 8 | 19 |
| Comparative Dye 2 | 9 | 22 |
| Comparative Dye 3 | 8 | 20 |

Clearly inks prepared using the dyes of the present invention display a clear advantage in light and ozone fastness.

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | Water | PG | DEG | NMP | TBT | BDL | PI2 |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A process for preparing phthalocyanine dyes and salts thereof or metallo-phthalocyanine dyes and salts thereof which comprises the stages of:
(a) cyclising a compound of Formula (1) with a compound of Formula (2) 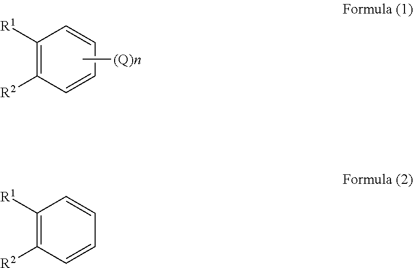
wherein:
R¹ and R² are cyano, carboxy, carboxamide or together form a group of formula 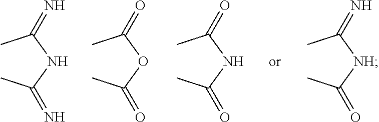
Q is NO₂, F or Cl; and
n is 1 to 4;
wherein the cyclisation process is carried out in the presence of a suitable nitrogen source (if required) and a metal salt (if required);
(b) chlorosulfonating the mixture of phthalocyanines or metallo-phthalocyanines formed in stage (a);
(c) reacting the mixture of phthalocyanines or metallo-phthalocyanines carrying sulfonyl chloride groups, formed in stage (b), with ammonia and one or more amines.

2. A process as claimed in claim 1 wherein the dyes are copper phthalocyanine dyes and salts thereof.

3. A process as claimed in claim 1 wherein Q is Cl.

4. A process as claimed in claim 1 wherein n is 4.

5. A process as claimed in claim 1 wherein the chlorosulfonating agent used in step (b) comprises a mixture of chlorosulfonic acid and phosphorous oxychloride.

6. A process as claimed in claim 1 wherein the amine(s) reacted in stage (c) is/are of Formula (3):
NHR³R⁴ Formula (3)
wherein:
R³ is selected from the group consisting of H, optionally substituted alkyl (optionally interrupted by one or more hetero atoms); optionally substituted aryl; and optionally substituted heterocyclylene (including optionally substituted heteroaryl); and
R⁴ is selected from the group consisting of optionally substituted alkyl (optionally interrupted by one or more hetero atoms); optionally substituted aryl; and optionally substituted heterocyclylene (including optionally substituted heteroaryl).

7. A process as claimed in claim 6 wherein the amine(s) of Formula (3) is/are of Formula (4):
NHR⁵-L-NR⁶R⁷ Formula (4)
wherein:
L is an divalent linking group;
R⁵ is H or optionally substituted alkyl;
R⁶ is H, optionally substituted alkyl (optionally interrupted by one or more hetero atoms), optionally substituted aryl or optionally substituted heterocyclyl; and
R⁷ is optionally substituted alkyl (optionally interrupted by one or more hetero atoms), optionally substituted aryl or optionally substituted heterocyclyl.

8. A process as claimed in claim 7 wherein R⁷ is a group of Formula (5) 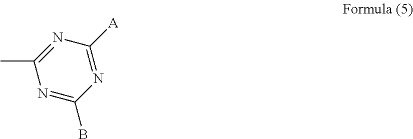
wherein:
A is selected from the group consisting of —OR⁸, —SR⁸, —NR⁸R⁹;
B is selected from the group consisting of —OR¹⁰, —SR¹⁰, —NR¹⁰R¹¹;
R⁸, R⁹, R¹⁰ and R¹¹ are independently H, optionally substituted alkyl, optionally substituted aryl or optionally substituted heterocyclyl provided that at least one of the groups represented by R⁸, R⁹, R¹⁰ and R¹¹ carries at least one substituent selected from the group consisting of —SO₃H, —CO₂H and —PO₃H₂.

9. A process as claimed in claim 7 wherein R⁷ is a group of Formula (6) 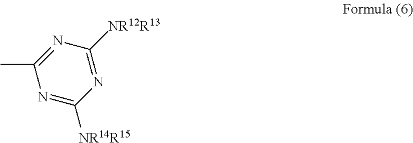
wherein:
R¹² is H or optionally substituted C₁₋₄alkyl;
R¹³ is H or optionally substituted C₁₋₄alkyl;
R¹⁴ is H or optionally substituted C₁₋₄alkyl;
R¹⁵ is optionally substituted alkyl, optionally substituted aryl or optionally substituted heterocyclyl carrying at least one substituent selected from the group consisting of —SO₃H, —CO₂H and —PO₃H₂.

10. Phthalocyanine dyes and salts thereof and/or metallo-phthalocyanine dyes and salts thereof obtainable by means of a process according to claim 1.

11. A metallo-phthalocyanine dyes and salts thereof, as claimed in claim 10, of Formula (7); 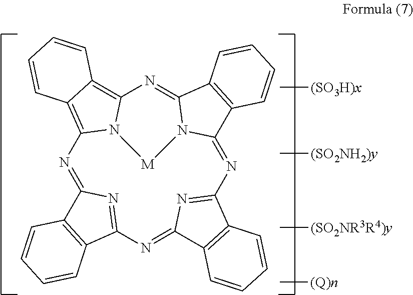
wherein
M is Ni or Cu;
R³ is selected from the group consisting of H, optionally substituted alkyl (optionally interrupted by one or more hetero atoms); optionally substituted aryl; and optionally substituted heterocyclylene (including optionally substituted heteroaryl);
R⁴ is selected from the group consisting of optionally substituted alkyl (optionally interrupted by one or more hetero atoms); optionally substituted aryl; and optionally substituted heterocyclylene (including optionally substituted heteroaryl);
Q is an electron withdrawing group;
N is 1 to 4;
x is greater than 0 and less than 4;
y is greater than 0 and less than 4;
z is greater than 0 and less than 4; and
y+z+w is greater than 0 and less than 4.

12. A composition comprising phthalocyanine dyes and salts thereof and/or metallo-phthalocyanine dyes and salts thereof, as claimed in claim 10 and a liquid medium.

13. A process for forming an image on a substrate comprising applying a composition according to claim 12 thereto by means of an ink-jet printer.

14. A material printed with phthalocyanine dyes and salts thereof and/or metallo-phthalocyanine dyes and salts thereof, as claimed in claim 10.

15. An ink-jet printer cartridge comprising a chamber and a composition, wherein the composition is in the chamber and the composition is as defined in claim 12.
